(19) United States
(12) Patent Application Publication
(10) Pub. No.: US 2007/0220901 A1
(43) Pub. Date: Sep. 27, 2007

(54) MAGNETIC REFRIGERATION MATERIAL AND MAGNETIC REFRIGERATION DEVICE

(75) Inventors: Tadahiko KOBAYASHI, Yokohama-shi (JP); Akiko Saito, Kawasaki-shi (JP); Hideyuki Tsuji, Yokohama-shi (JP); Tetsuya Tachibe, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 11/675,839

(22) Filed: Feb. 16, 2007

(30) Foreign Application Priority Data
Mar. 27, 2006 (JP) 2006-085473

(51) Int. Cl. F25B 21/00; C04B 35/40

(52) U.S. Cl. 62/3.1; 252/62.57

(57) ABSTRACT

A magnetic refrigeration material has magnetic material particles with a magnetocaloric effect and an oxidation-resistant film formed on the surfaces of the magnetic material particles.

### CROSS-REFERENCE TO RELATED APPLICATION

This application is based upon and claims the benefit of priority from the prior Japanese Patent Application No. 2006-85473, filed on Mar. 27, 2006; the entire contents of which are incorporated herein by reference.

### BACKGROUND OF THE INVENTION

1. Field of the Invention

The invention relates to a magnetic refrigeration material using a magnetic material having a magnetocaloric effect and a magnetic refrigeration device.

2. Description of the Related Art

For a magnetic refrigeration system using a magnetic material, a refrigeration system using paramagnetic salts such as Gd₂(SO₄)₃*8H₂O and paramagnetic compounds represented by Gd₃Ga₅O₁₂ (gadolinium gallium garnet: GGG) as working substances for magnetic refrigeration having a magnetocaloric effect was developed in the early 1900s. A refrigeration system realizing magnetic refrigeration by using a paramagnetic substance is mainly applied to an low temperature region of 20 K or less, and a magnetic field of about 10 Tesla which can be obtained by using a superconductive magnet is used.

On the other hand, to realize the magnetic refrigeration at higher temperatures, the research on the magnetic refrigeration using the magnetic phase transition of a ferromagnetic material between a paramagnetic state and a ferromagnetic state was extensively made after the 1970s. As a consequence, there have been proposed a large number of magnetic materials containing rare earth elements having a large electron magnetic spin per unit volume, such as lanthanoide rare earth elements such as Pr, Nd, Dy, Er, Tm, and Gd, rare earth alloy materials containing two or more rare earth elements such as Gd—Y and Gd—Dy, and rare earth intermetallic compounds such as RAl₂ (R represents a rare earth element, and this similarly applies to the following description), RNi₂, and GdPd.

In 1974, Brown (U.S.A.) achieved magnetic refrigeration in a room temperature region for the first time by using a ferromagnetic substance Gd having a ferromagnetic phase transition temperature (Tc) of about 294 K Although the refrigeration cycle was continuously operated in the Brown's experiment, a steady state could not be achieved. In 1982, Barclay (U.S.A.) devised to use rather positively the lattice entropy that had been regarded as an interference to magnetic refrigeration in the room temperature region and proposed a method of refrigeration by which a magnetic material is also made to have a heat accumulation effect for accumulating the cold heat produced by the magnetic refrigeration work in addition to the magnetic refrigeration work by the magnetocaloric effect. This magnetic refrigeration method is called an AMR method (Active Magnetic Refrigeration). Both the above refrigeration systems operate in a strong magnetic field by using a superconductive magnet (e.g., U.S. Pat. No. 4,332,135).

In 1997, Zimm, Gschneidner and Pecharsky (U.S.A.) experimentally manufactured an AMR magnetic refrigerator using a packed column filled with fine particulate Gd and succeeded in a continuous steady operation of the magnetic refrigeration cycle in a room temperature region. It was reported that refrigeration at about 30 degrees C. was succeeded by changing the magnetic field from 0 to 5 Tesla by using a superconducting magnet in the room temperature region, and when the refrigerating temperature difference (ΔT) was 13 degrees C., a very high refrigeration efficiency (COP=15; excluding the power input to the magnetic field generating means) was obtained. In this regard, the refrigeration efficiency (=coefficient of performance:COP) of a compression cycle of a household refrigerator or the like using conventional freon is about 1 to 3.

As magnetic materials which develop a magnetocaloric effect, there have been found, for example, a Gd compound comprised of a mixture of Gd (gadolinium) and a variety of elements, an intermetallic compound comprised of a variety of rare-earth elements and transition metal elements, Ni₂MnGa, MnAsSb, Gd₅(GeSi)₄, LaFe₁₃, LaFe₁₃H and the like. Magnetic refrigeration technology using such a magnetic material having a magnetocaloric effect is being watched with interest as cryogenic technology of which effects on the environment is quite low because it has high efficiency and does not cause destruction of the ozone layer resulting from freon gases, substitute freon gases or the like which is a problem in gas refrigeration or does not have inflammability or toxicity of ammonia, isobutene and the like.

The magnetic refrigeration technology repeats a AMR heat cycle operation by applying and removing a magnetic field to and from a magnetic material having a magnetocaloric effect to perform temperature gradient of the heat absorption and heat generation of the magnetic material into a high temperature and a low temperature with a heat transfer fluid. Therefore, heat conductivity of the magnetic material surface contributes to a heat exchange efficiency because a change in thermal energy of the magnetic material is undergone a heat transport by a cooling medium (liquid). But, it was found that a particular oxidized layer, a heterogeneous surface layer and the like might be formed on the magnetic material surface to degrade the heat conductivity of such surface layers, and the heat exchange efficiency was degraded considerably.

### SUMMARY OF THE INVENTION

The invention provides a magnetic refrigeration material and a magnetic refrigeration device that can prevent the heat exchange efficiency from lowering due to the heterogeneous surface layer such as an oxidized layer formed on the magnetic material surface, and can improve the heat exchange efficiency better than related art.

According to an aspect of the present invention, the invention provides a magnetic refrigeration material/device include, comprising magnetic material particles with a magnetocaloric effect and an oxidation-resistant film formed on the surfaces of the magnetic material particles.

### BRIEF DESCRIPTION OF THE DRAWINGS

FIG. 1 is a diagram schematically showing an outline sectional structure of a main portion of a magnetic refrigeration device according to an embodiment of the invention.

FIG. 2 is a diagram showing an outline sectional structure of the whole of the magnetic refrigeration device according to the embodiment of the invention.

FIG. 3 is a magnified diagram showing an outline sectional structure of a magnetic refrigeration material according to the embodiment of the invention.

FIG. 4 is a graph showing a relationship between a temperature span and a AMR heat cycle frequency.

### DESCRIPTION OF THE EMBODIMENTS

Embodiments of a magnetic refrigeration material and a magnetic refrigeration device according to the invention will be described with reference to the drawings.

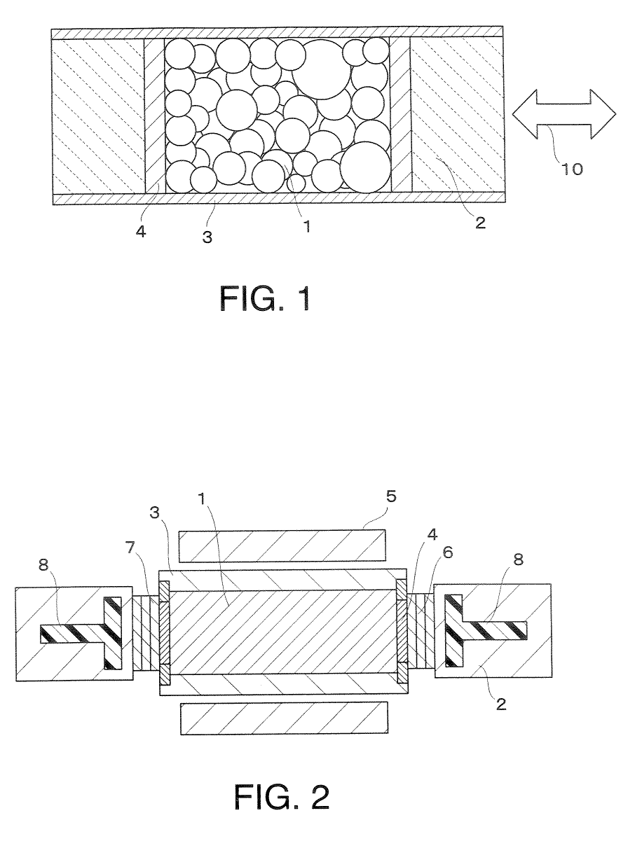

As shown in FIG. 1 and FIG. 2, the magnetic refrigeration device according to the embodiments is provided with a heat-exchange vessel 3. A separator 4 is disposed on either side of the heat-exchange vessel 3 to hold a magnetic refrigeration material 1 which is filled in the heat-exchange vessel 3. The separator 4 has a structure to hold the magnetic refrigeration material 1 and to allow the passage of a heat transfer fluid 2. It is formed to have, for example, a mesh form. The heat transfer fluid 2 performs heat transport of a temperature change of the magnetic refrigeration material 1, and a heat transfer fluid such as pure water, ethanol or ethylene glycol is used. This heat transfer fluid 2 is moved in a fluid flowing direction indicated by a bidirectional arrow 10 of FIG. 1. As this flowing means (heat transfer fluid delivery mechanism), a pump which is configured of pistons 8 and the like shown in, for example, FIG. 2 is used. The magnetic refrigeration material 1 is magnetic material spherical powder (hereinafter simply referred to as magnetic material spherical powder) having a magnetocaloric effect, and specifically, spherical powder formed of, for example, a rare earth element such as Gd, GdDy or GdY and its compound or Gd₅(GeSi)₄ LaFe₁₃, LaFe₁₃H or the like. The magnetic refrigeration material 1 is used in spherical powder form.

The magnetic refrigeration material 1 used has generally an average particle diameter of about 0.1 mm to 2 mm. If the average particle diameter is less than 0.1 mm, the heat transfer fluid flowing through the spherical powder has a large pressure loss, and if it is larger than 2 mm, a contact area between the magnetic refrigeration material 1 and the heat transfer fluid 2 becomes small, and a heat exchange efficiency lowers. A more preferable average particle diameter is 0.3 mm to 1.2 mm, and where a liquid is used as the heat transfer fluid 2, it is desirably 0.5 mm or more.

As shown in FIG. 2, a magnet 5 is disposed around the heat-exchange vessel 3. This magnet 5 is moved with respect to the heat-exchange vessel 3 to apply and remove a magnetic field, thereby moving the heat transfer fluid 2 by the pistons 8. A temperature difference between a low temperature portion 6 and a high temperature portion 7 obtained by repeating the AMR heat cycle operation is a temperature span, and a Curie temperature, an amount of magnetic entropy change, heat conductivity and a temperature span depending on an measurement temperature of the magnetic refrigeration material 1 can be determined.

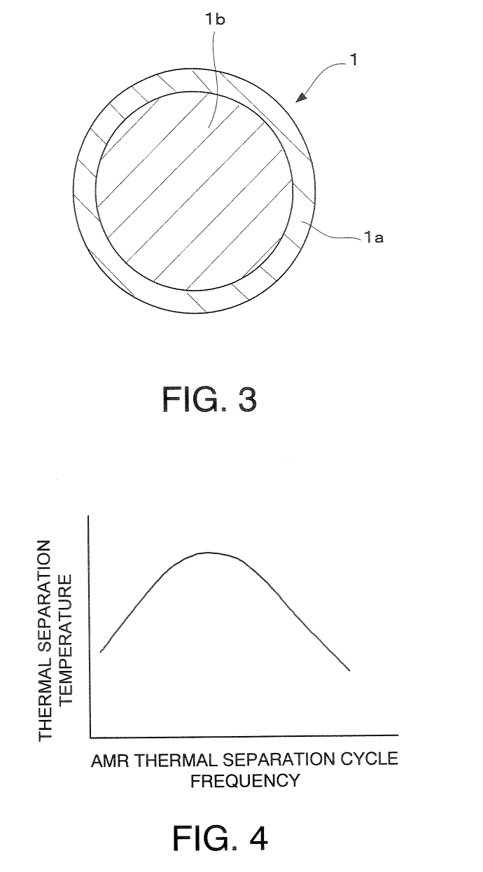

Here, as the heat exchange between the magnetic refrigeration material 1 and the heat transfer fluid 2, a heat transporting operation (heat transport) by the heat transfer fluid 2 is performed through the surface of the magnetic refrigeration material 1 having a temperature change. At this time, if the surface of the magnetic refrigeration material 1 is covered with an oxidized film having low heat conductivity, heat quantity transported by the heat transfer fluid 2 lowers. In this embodiment, an oxidized film having low heat conductivity or the like can be prevented from being formed on the surface of the magnetic refrigeration material 1 by using the magnetic refrigeration material 1 having an oxidation-resistant film 1a formed on the surface of a magnetic material particle 1b as shown in FIG. 3. And, the heat quantity transported by the heat transfer fluid 2 can be prevented from lowering by selecting a film formed of a material having high heat conductivity as the oxidation-resistant film 1a.

The magnetic refrigeration technology uses heat absorption and heat generation of the magnetic refrigeration material 1 along with the application and removal of the external magnetic field, so that the oxidation-resistant film 1a is preferably a nonmagnetic material. In other words, the external magnetic field is applied to the magnetic refrigeration material 1, but where the oxidation-resistant film 1a formed on the surface is a magnetic material, the external magnetic field is shielded to decrease an effective magnetic field, and the heat exchange efficiency is lowered.

The magnetic refrigeration material 1 causes heat absorption and heat generation with the application and removal of the external magnetic field to repeat the AMR heat cycle operation, thereby performing thermal separation of the temperature change to the low temperature portion 6 and the high temperature portion 7 with the heat transfer fluid 2. Therefore, where the surface of the magnetic refrigeration material 1 is covered with an oxidized film having low heat conductivity, it is necessary to lower the heat cycle operating frequency, and the refrigeration efficiency is degraded. In other words, a thermal time constant becomes large because of the oxidized film having low heat conductivity, and a time period in which a temperature change of the magnetic refrigeration material 1 saturates becomes long. From this point of view, the increase of the heat conductivity of the surface layer of the magnetic refrigeration material 1 contributes largely to the provision of high efficiency.

The AMR heat cycle operation repeats a cycle of applying a magnetic field to the magnetic refrigeration material 1, transporting the heat generation of the magnetic refrigeration material 1 to a high temperature end side (high temperature portion 7) by the heat transfer fluid 2, removing the magnetic field from the magnetic refrigeration material 1, and transporting the absorbed heat to the low temperature end side (low temperature portion 6) by the heat transfer fluid 2. Here, heat at the low temperature end is moved into, for example, a freezer to produce a low temperature, and the heating value at the high temperature end is discharged by, for example, a heat radiating fin. Naturally, the heating value at the high temperature end can also be used effectively to apply to an air-conditioning system for cooling and heating.

As described above, the heat exchange efficiency can be prevented from lowering considerably by forming the high thermal conductive oxidation-resistant film 1a on the surface of the magnetic refrigeration material 1, but the magnetic refrigeration material 1 is exposed to the atmosphere during its manufacturing process, and a film might be formed on it because of unavoidable oxidation. The formation of the oxidized film degrades the heat conductivity. For example, where Gd is used, the heat conductivity is about 9 W/m·K at about room temperature, but where Gd₂O₃ is used, it lowers to about 5 W/m·K. In such a case, because heat conduction is inhibited even by formation of the oxidation-resistant film 1a on the surface layer (oxidized film) of Gd, it is desirable to remove the surface layer before the oxidation-resistant film 1a is formed. As a method of removing the surface layer, a surface treatment for chemical removal with an acid or alkaline solution can be used. And, shot peening, barrel-polishing or the like can also be used as a mechanical polishing method. In addition, a process of continuously disposing a high heat conductive material after the surface treatment (removal of the surface layer) by plasma etching can also be used.

The above-described oxidation-resistant film 1a has desirably heat conductivity larger than that of the magnetic material spherical powders 1b, preferably 9 W/m·K or more. If the heat conductivity is lower than that, the heat exchange efficiency lowers considerably. Meanwhile, a heat cycle operating frequency can be increased higher as the heat conductivity is larger than 9 W/m·K, so that high efficiency can be obtained, and rapid cooling and refrigeration can also be realized simultaneously.

To form the oxidation-resistant film 1a, a chemical method represented by a plating treatment may be used, and a vapor deposition method, a sputtering method or the like may be used as a film-forming process. In addition, an ion plating method may be used to form a film by ionizing in a high-frequency excitation plasma atmosphere. Meanwhile, the oxidation-resistant film 1a is desired to have high heat conductivity and, for example, Al₂O₃, Si₃N₄, MgO, AlN, SnO₂, Y₂O₃, ZnO, ZrO₂, Ag, Au, Al, Cr, Cu, Ti, Zn, and Zr can be used. The plating method may constitute a factor of inhibiting the heat conduction by disposing a material having low heat conductivity for a base layer, so that it is also necessary to use a high heat-conductive material for the base layer.

As a material for the above-described oxidation-resistant film 1a, aluminum oxide and aluminum nitride can be used particularly suitably. In such a case, the good oxidation-resistant film 1a can be formed by performing an oxidation treatment or nitrogenization treatment after aluminum is formed on the surfaces of the magnetic material spherical powders 1b by ion plating. For example, in a case where LaFe₁₃H is used, hydrogen withdrawal occurs because of exposure to a high temperature of about 300 degrees C. or more, and Curie temperature drops sharply, so that the process of forming the oxidation-resistant film 1a must be a low-temperature process. But, even in such a case, when the above process is used, the oxidation-resistant film 1a can be formed easily by the low-temperature process.

As a material for the above-described oxidation-resistant film 1a, Au, Al or Cu which is formed by the plating method is also preferable. Where such a plating method is used, thermal damage is not applied to the magnetic refrigeration material 1 because a heat treating process is not used. Therefore, stable properties can be maintained, and heat exchange efficiency and abrasion resistance can be improved at the same time. Besides, in a case where the oxidation-resistant film 1a formed of Cu is exposed to a heat transfer fluid such as pure water, a film of copper oxide or the like is formed to degrade the heat conductivity, so that it is preferable to apply, for example, an acrylic or ester discoloration preventing agent. The discoloration preventing agent is desired to be coated in a thickness of 1 μm or less. If the thickness is greater, the heat conductivity lowers, and the heat exchange efficiency is degraded. The discoloration preventing agent must be prepared depending on the material used for the oxidation-resistant film. Generally, in a case where the oxidation-resistant film is copper or copper alloy, the discoloration preventing agents are desirably Chiolight C-10B (trade name, manufactured by Chiyoda Chemical Co., Ltd.), MY-648 (trade name, manufactured by NIPPON HYOMEN KAGAKU KABUSHIKI KAISHA), and BT-8 (trade name, manufactured by KITAIKE SANGYO CO., LTD.). And, where the oxidation-resistant film is based on a kind of aluminum, the discoloration preventing agent may be Chiolight C-410 (trade name, manufactured by Chiyoda Chemical Co., Ltd.).

Besides, the oxidation-resistant film 1a also has effects of improving corrosion resistance and mechanical reliability. The corrosion resistance also has effects of oxidation resistance in the atmosphere and prevention of corrosion due to the heat transfer fluid 2. Besides, the magnetic refrigeration material 1 and the heat transfer fluid 2 produce friction with the heat transfer fluid at the time of the heat exchange, but abrasion resistance is improved by the oxidation-resistant film 1a, and pulverization to be caused due to fluid friction can be prevented. And, the heat exchanger 3 in which the magnetic refrigeration material 1 is filled is operated to apply and remove the magnetic field to and from the magnet 5, so that the magnetic refrigeration material 1 is in friction by being affected by a magnetic torque. The oxidation-resistant film 1a also exhibits an effect to improve the abrasion resistance against such friction.

The thickness of the oxidation-resistant film 1a has an influence upon a heat conduction property, and an average film thickness is desirably set to 1 to 50 μm considering the above-described corrosion resistance and mechanical reliability. If it is less than 1 μm, the mechanical reliability cannot be obtained, and the possibility of occurrence of pulverization becomes high. And, even if it is corrosion resistant, a progress of corrosion increases. It provides a synergistic effect with the mechanical reliability. In other words, the fluid friction produces lots of missing portions, and the corrosion progresses selectively from the missing portions. Meanwhile, if it is greater than 50 μm, it is advantageous for the corrosion resistance and mechanical reliability but not desirable for the original heat exchange. In other words, the magnetic refrigeration material 1 to be filled into the heat-exchange vessel 3 can increase the heat exchange efficiency higher as the surface area in contact with the heat transfer fluid 2 is larger, but if the oxidation-resistant film 1a has a thickness larger than 50 μm, the ratio occupied by the magnetic material particles 1b becomes small, and refrigeration output decreases. If the filling rate is increased to a level larger than the necessity, a pressure loss increases due to the fluid friction with the heat transfer fluid 2, and heat generation due to Joule heating cannot be ignored. In view of the above circumstances, it is more desirable that the average film thickness is 4 to 15 μm.

In the AMR heat cycle by the magnetic refrigeration device, the heat transfer fluid 2 passes through the magnetic refrigeration material 1, so that the pressure loss is caused as described above. Part of the loss becomes friction heating (=Joule heating) generated by the heat transfer fluid 2 and the magnetic refrigeration material 1, and the heat exchange efficiency is inhibited. Meanwhile, the AMR heat cycle has the application and removal of the magnetic field (magnetic field ON-OFF) applied to the magnetic refrigeration material by the magnet 5. If the frequency of the AMR heat cycle increases, energy generated per unit time of the heat transport increases, so that the temperature span becomes higher, and the heat exchange efficiency is also improved. But, when the magnetic field ON-OFF is quickened, an eddy current generated in the magnetic refrigeration material 1 also increases. Besides, a hysteresis loss is generated in a ferromagnetic area (temperature lower than the Curie temperature), and Joule heating is applied. Therefore, the optimum value of a cycle frequency is expressed as shown in FIG. 4. In other words, the frequency and the temperature span are improved, a peak is determined in a given frequency range, and then the magnetic refrigeration material 1 itself generates heat by Joule heating because of the eddy current and the hysteresis loss, so that the temperature span decreases.

The heat generation by the eddy current is largely influenced by the oxidation-resistant film 1a formed on the surface of the magnetic refrigeration material 1. This also relates to the above-described average film thickness, and if the average film thickness becomes larger than 50 μm, an eddy current effect becomes prominent. Therefore, it also relates to the AMR heat cycle frequency, but when the oxidation-resistant film 1a has a good heat conduction property (low electric resistance), it is desirable that the average film thickness is 50 μm or less considering the use of a high frequency.

### EXAMPLE 1

Gd was used to produce spherical powder having a diameter of 0.1 to 2.0 mm in an inert gas by a rotating electrode process (REP). The Gd spherical powder was subjected to surface analysis to find that it was covered with a thin gadolinium oxide layer. It was an oxidized layer formed by the exposure to the atmosphere after forming the spherical powder. The oxidized layer had low heat conductivity of up to 5 W/m·K, inhibiting the heat exchange efficiency. Then, Gd spheres which were classified into a diameter of about 500 μm were immersed in a 0.001 to 0.01% solution of hydrochloric acid at normal temperature for about 5 minutes to 30 minutes or in an about 1 to 3% solution of sodium hydroxide at 90 degrees C. for about 1 to 10 minutes. Subsequently, the Gd spheres were put in a mesh basket and stirred by rotating to form an aluminum layer on the surface in an inert gas by an ion plating method. The aluminum layer was determined to have an average film thickness of about 0.1 μm for Sample 1, about 40 μm for Sample 2 and about 120 μm for Sample 3 in terms of a vapor deposition speed. They were kept exposed to the atmosphere and their surfaces were analyzed to find that an aluminum oxide layer was formed.

The obtained samples were respectively charged in about 100 g into the magnetic refrigeration device based on the AMR heat cycle shown in FIG. 2, temperature spans were measured at room temperature of 21 degrees C. and their surfaces were visually observed to obtain the results as shown in Table 1. The magnetic field strength was 0.7 T, and the heat transfer fluid was pure water. As shown in Table 1, Sample 1 having the average film thickness of 0.1 μm was observed having partly black-colored portions where corrosion proceeded due to the pure water. And, the temperature span of Sample 3 having the average film thickness of 120 μm was dropped sharply. Therefore, it is desired that the oxidation-resistant film 1a has an average film thickness of about 1.0 to 50 μm.

TABLE 1

| | Average film | Temperature | Visual |
|---|---|---|---|
| | Thickness | span | surface |
| | μm | ° C. | observation |
| Sample 1 | 0.1 | 9.5 | Partial |
| | | | discoloration |
| Sample 2 | 40 | 10.1 | OK |
| Sample 3 | 120 | 8.3 | OK |
| Sample 4 | 5 | 10.5 | OK |
| Sample 5 | 5 | 10.0 | OK |
| Sample 6 | 4 | 9.2 | OK |
| Sample 7 | 4 | 9.0 | OK |
| Sample 8 | 15 | 9.2 | OK |

### EXAMPLE 2

After the washing process with the acid or alkaline solution of Example 1, Sample 4 (an average film thickness of 5 μm) Au-plated and Sample 5 (an average film thickness of 5 μm) Cr-plated were subsequently produced. The obtained samples were filled in about 100 g into the magnetic refrigeration device based on the AMR heat cycle shown in FIG. 2 and checked for a temperature span at room temperature of 21 degrees C. to obtain the results as shown in Table 1. As shown in Table 1, both Sample 4 and Sample 5 had a good temperature span, and no abnormality was observed when the surfaces were visually observed after the test.

### EXAMPLE 3

After a mother alloy of LaFe₁₃ was produced, spherical powder having a diameter of 0.3 to 1.3 mm was produced in an inert gas by the rotating electrode process (REP). The spherical powder was subjected to a heat treating process and a hydrogenating process to obtain LaFe₁₃H spheres having a Curie temperature of about 19 degrees C. Then, after the washing process with the same acid or alkaline solution as that described in Example 1, Sample 6 (an average film thickness of 5 μm) Au-plated and Sample 7 (an average film thickness of 5 μm) Cr-plated were produced. The obtained samples were filled in about 100 g into the magnetic refrigeration device based on the AMR heat cycle shown in FIG. 2 and checked for a temperature span at room temperature of 19 degrees C. to obtain the results as shown in Table 1. As shown in Table 1, both Sample 6 and Sample 7 had a good temperature span, and no abnormality was observed when the surfaces were visually observed after the test.

### EXAMPLE 4

After the washing process with the acid or alkaline solution of Example 1, Sample 8 (an average film thickness of 10 μm) Cu-plated was subsequently produced. Besides, a special ester-based discoloration preventing agent was used to form a coated layer having a thickness of 0.15 μm on the surface of Sample 8. The obtained sample was filled in about 100 g into the magnetic refrigeration device based on the AMR heat cycle shown in FIG. 2 and checked for a temperature span at room temperature of 21 degrees C. to obtain the results as shown in Table 1. As shown in Table 1, Sample 8 also had a good temperature span, and no abnormality was observed when the surface was visually observed after the test.

### COMPARATIVE EXAMPLE 1

As comparative examples, Sample 9, Sample 10 and Sample 11, which were prepared without washing the surfaces of the Gd spheres of Example 1 and forming the oxidation-resistant film 1a, were filled in about 100 g into the magnetic refrigeration device based on the AMR heat cycle shown in FIG. 2 and checked for a temperature span at room temperature of 21° C. to obtain the results as shown in Table 2. Sample 9, Sample 10 and Sample 11 shown in Table 2 were produced by a different batch treatment. As shown in Table 2, the temperature span was low, and the properties were variable among the individual batches in Comparative Example 1.

TABLE 2

| | Temperature span |
|---|---|
| | ° C. |
| Sample 9 | 8.4 |
| Sample 10 | 6.5 |
| Sample 11 | 7.9 |
| Sample 12 | 5.2 |
| Sample 13 | 5.5 |

### COMPARATIVE EXAMPLE 2

Sample 12, which was prepared without washing the surfaces of the LaFe₁₃H spheres used in Example 3 and forming the oxidation-resistant film 1a, was filled in about 100 g into the magnetic refrigeration device based on the AMR heat cycle shown in FIG. 2 and checked for a temperature span at room temperature of 19 degrees C. to obtain the results as shown in Table 2. As shown in Table 2, the temperature span was also low apparently in Comparative Example 2 in comparison with Example 3. In a case where pure water was used as the heat transfer fluid, a reddish brown corrosion product was visually observed after one day.

### COMPARATIVE EXAMPLE 3

As a comparative example, Sample 13, which was prepared with a Cu oxidation-resistant film 1a formed without washing the surfaces of the Gd spheres of Example 1 and without applying a discoloration preventing agent, was filled in about 100 g into the magnetic refrigeration device based on the AMR heat cycle shown in FIG. 2 and checked for a temperature span at room temperature of 21° C. to obtain the result as shown in Table 2. As shown in Table 2, Sample 13 had a low temperature span.

As described above, the present embodiments can perform the AMR heat cycle operation for performing thermal separation of the heat absorption and heat generation of the magnetic material associated with the application and removal of the external magnetic field into a high temperature and a low temperature with a heat transfer fluid at a high efficiency. And, a highly reliable magnetic refrigeration material can be provided in view of the phenomena, such as corrosion resistance, abrasion resistance and mechanical strength by the heat transfer fluid, unique to the AMR heat cycle operation.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A magnetic refrigeration material, comprising:
magnetic material particles having a magnetocaloric effect; and
an oxidation-resistant film formed on the surfaces of the magnetic material particles.

2. The magnetic refrigeration material according to claim 1,
wherein the oxidation-resistant film is formed of a nonmagnetic material.

3. The magnetic refrigeration material according to claim 1,
wherein the oxidation-resistant film is formed after removing the surface layer which is formed on the surfaces of the magnetic material particles.

4. The magnetic refrigeration material according to claim 1,
wherein the oxidation-resistant film has a heat conductivity of 9 W/m·K or more.

5. The magnetic refrigeration material according to claim 1,
wherein the oxidation-resistant film is at least one kind of element selected from aluminum oxide and aluminum nitride.

6. The magnetic refrigeration material according to claim 1,
wherein the oxidation-resistant film is copper, and the surface of the oxidation-resistant film is coated with a discoloration preventing agent.

7. The magnetic refrigeration material according to claim 1,
wherein the oxidation-resistant film has an average film thickness of 1 to 50 μm.

8. The magnetic refrigeration material according to claim 1,
wherein the magnetic material particles are formed of an LaFe₁₃ magnetic material.

9. A magnetic refrigeration device, comprising:
a magnetic refrigeration material having magnetic material particles with a magnetocaloric effect and an oxidation-resistant film formed on the surfaces of the magnetic material particles;
a housing section for housing the magnetic refrigeration material;
a magnet for applying a magnetic field to the magnetic refrigeration material within the housing section; and
a heat transfer fluid delivery mechanism for flowing a heat transfer fluid in the housing section.

10. The magnetic refrigeration device according to claim 9,
wherein the oxidation-resistant film is made of a nonmagnetic material.

11. The magnetic refrigeration device according to claim 9,
wherein the oxidation-resistant film is formed after removing the surface layer which is formed on the surfaces of the magnetic material particles.

12. The magnetic refrigeration device according to claim 9,
wherein the oxidation-resistant film has a heat conductivity of 9 W/m·K or more.

13. The magnetic refrigeration device according to claim 9,
wherein the oxidation-resistant film is at least one kind of element selected from aluminum oxide and aluminum nitride.

14. The magnetic refrigeration device according to claim 9,
wherein the oxidation-resistant film is copper, and the surface of the oxidation-resistant film is coated with a discoloration preventing agent.

15. The magnetic refrigeration device according to claim 9,
wherein the oxidation-resistant film has an average film thickness of 1 to 50 μm.

16. The magnetic refrigeration device according to claim 9,
wherein the magnetic material particles are formed of an LaFe₁₃ magnetic material.
